(19) United States
(12) Patent Application Publication
(10) Pub. No.: US 2017/0142782 A1
(43) Pub. Date: May 18, 2017

(54) HEATING COOKER

(71) Applicant: Panasonic Intellectual Property Management Co., Ltd., Osaka (JP)

(72) Inventors: NAOKI YAMASAKI, Shiga (JP); TAKAYUKI HAYAMI, Osaka (JP); YASUHIRO BAN, Saitama (JP); TAKAHIRO MIYAUCHI, Hyogo (JP); KOHJI NIIYAMA, Hyogo (JP)

(21) Appl. No.: 15/322,233

(22) PCT Filed: Jul. 10, 2015
(86) PCT No.: PCT/JP2015/003496

§ 371 Date: Dec. 27, 2016

(30) Foreign Application Priority Data
Jul. 14, 2014 (JP) 2014-143825

(51) Int. Cl. H05B 6/12

(52) U.S. Cl. CPC H05B 6/1272; H05B 2213/03; H05B 2213/05

(57) ABSTRACT

In a heating cooker, multiple IH coils (3) are provided under a top plate, so as to heat an object to be heated by induction heating. Operation display unit (7) is configured with touch panel (5) to display information prompting an operation via touch panel (5) and receive an input of the operation via touch panel (5). Control unit (202) controls operation display unit (7) and drive unit (203), according to an operation input to operation display unit (7). Control unit (202) also sets a selection region on touch panel (5) and a heating region on the top plate, according to a drag operation on touch panel (5). Operation display unit (7) displays a selection region. Drive unit (203) drives one or more IH coils (3) corresponding to the heating region. This configuration enables to offer an inexpensive heating cooker with higher flexibility in the placement position of the object to be heated, without compromising its operability.

### TECHNICAL FIELD

The disclosure relates to operation display devices employed in heating cookers having induction heating coils.

### BACKGROUND ART

This type of heating cookers conventionally includes a heater having multiple (e.g., three) induction heating coils (hereinafter referred to as “IH coil”) under a top plate, a power display unit for displaying the power level of each IH coil, and an operation unit for executing operations of each IH coil, such as a change of the power level.

In this type of heating cookers, one known configuration provides the power display unit and the operation unit on the top plate near each IH coil (e.g., PTL1). This configuration facilitates understanding of which power display unit and operation unit correspond to which IH coil.

The above prior art is configured to induction-heat one object to be heated (e.g., pot) by one IH coil. The user thus needs to place the heating pot on a predetermined position on the top plate.

Recently, however, a heating cooker that enables to induction-heat an object to be heated placed at any position on the top plate has been proposed. This heating cooker has many IH coils smaller than the ordinary size, arranged typically in matrix under the entire top plate (e.g., PTL2).

In the heating cooker in the above prior art, many infrared-ray sensors are provided under the top plate to detect the position of the object to be heated based on information from the infrared-ray sensors. In addition, the heating cooker in the prior art offers comfortable operation by providing the power display unit and the operation unit near the object to be heated.

### CITATION LIST

### Patent Literature

PTL1 Japanese Patent Unexamined Publication No. 2007-18786

PTL2 Japanese Patent Unexamined Publication No. 2009-238575

### SUMMARY OF INVENTION

However, the above prior art, PTL2, requires a means for accurately detecting an object to be heated, such as many infrared-ray sensors for detecting the position of the object to be heated. Accordingly, the price of this type of heating cookers is high.

A heating cooker of the disclosure aims to offer an inexpensive heating cooker with higher flexibility in the placement position of a heating cooker without compromising operability.

To solve a disadvantage of the prior art, the heating cooker in an exemplary embodiment of the disclosure includes a top plate, multiple IH coils, operation display unit, drive unit, and control unit.

Multiple IH coils are provided under the top plate on which an object to be heated is placed, so as to heat the object to be heated by induction heating. The operation display unit configured with a touch panel displays information prompting an operation via the touch panel, and receives an input of the operation via the touch panel. The drive unit drives the IH coils. The control unit controls the operation display unit and drive unit according to the operation input to the operation display unit.

Still more, the control unit sets a selection region on the touch panel and a heating region on the top plate by a drag operation on the touch panel. The operation display unit displays the selection region. The drive unit drives one or more IH coils corresponding to the heating region.

In the exemplary embodiment, the heating region on the top plate can be set by the touch operation and drag operation on the touch panel. Consequently, flexibility in the placement position of the object to be heated can be improved.

Furthermore, the exemplary embodiment does not require infrared-ray sensors for detecting the position of the object to be heated placed on the top plate. The exemplary embodiment can thus offer the above heating cooker inexpensively.

### BRIEF DESCRIPTION OF DRAWINGS

FIG. 1 is a perspective view of appearance of a heating cooker in accordance with an exemplary embodiment of the disclosure.

FIG. 2 is a block diagram of the control of the heating cooker in accordance with the exemplary embodiment.

FIG. 3 is a flow chart indicating a method of setting a selection region and a heating region in accordance with the exemplary embodiment.

FIG. 4 illustrates the state that an initial image is displayed.

FIG. 5 illustrates the state of a section lighted by a touch operation.

FIG. 6 illustrates the state that multiple adjacent sections are lighted by drag operation.

FIG. 7 illustrates the state that multiple adjacent sections are lighted by drag operation.

FIG. 8 is a flow chart indicating a method of setting the operation states of the selection region and the heating region in accordance with the exemplary embodiment.

FIG. 9 illustrates the state that a setting region is displayed.

FIG. 10 illustrates the state that an operation state is displayed in the setting region.

### DESCRIPTION OF EMBODIMENTS

A heating cooker in a first embodiment of the disclosure includes a top plate, multiple IH coils, operation display unit, drive unit, and control unit.

The IH coils are provided under the top plate on which an object to be heated is placed, so as to heat the object to be heated by induction heating. The operation display unit configured with a touch panel displays information prompting an operation via the touch panel, and receives an input of the operation via the touch panel. The drive unit drives multiple IH coils. The control unit controls the operation display unit and drive unit, according to operations input to the operation display unit.

The control unit also sets a selection region on the touch panel, and a heating region on the top plate, according to the drag operation on the touch panel. The operation display unit displays the selection region. The drive unit drives one or more IH coils corresponding to the heating region.

In the embodiment, the heating region can be set on the top plate by the touch operation and drag operation on the touch panel. Consequently, flexibility in the placement position of the object to be heated can be improved.

Still more, the embodiment does not require infrared-ray sensors for detecting a position of an object to be heated placed on the top plate. Accordingly, the embodiment can offer the above heating cooker inexpensively.

A heating cooker in a second embodiment of the disclosure is configured to display a selectable region for setting the selection region on the operation display unit in the first embodiment. In the embodiment, the user can easily and visually recognize a region where a selection region can be set on the touch panel.

A heating cooker in a third embodiment of the disclosure is configured to display a setting region for setting an operation state of the heating region on the operation display unit, according to the operation of the selection region in the first embodiment.

The user can easily and visually recognize that the displayed setting region is for setting the operation state of the heating region corresponding to the selection region operated just before.

A heating cooker in a fourth embodiment of the disclosure includes a setting icon for setting an operation state of the heating region in the third embodiment. According to an operation of this setting icon, the operation display unit displays another setting icon in the setting region.

The embodiment can improve operability because a new setting icon that can be operated subsequently is displayed in turn every time an operation is input to the current setting icon, without displaying many setting icons on the operation display unit at once.

A heating cooker in a fifth embodiment is configured to display the operation state of the heating region in or near the selection region of the operation display unit in the third embodiment. In the embodiment, the user can easily and visually recognize the position of the heating region and the operation state of this heating region.

A heating cooker in a sixth embodiment of the disclosure is configured to delete the setting region on the operation display unit when setting of the operation state of the setting region is completed. In the embodiment, the user can save the effort by automatically deleting the setting region when a predetermined condition is fulfilled.

A heating cooker in a seventh embodiment of the disclosure is configured to delete a setting region from the operation display unit after a predetermined time passes since the setting region starts to be displayed in the third embodiment. In the embodiment, the user can save the effort by automatically deleting the setting region when a predetermined condition is fulfilled.

A heating cooker in an eighth embodiment of the disclosure is configured such that the control unit sets another selection region on the touch panel while a setting region is displayed, according to a drag operation on the touch panel, and then sets a new heating region on the top plate, corresponding to this another selection region; and the operation display unit displays a new setting region for setting the operation state of this new heating region.

The embodiment enables to set multiple heating regions on the top plate and an operation state for each of the heating regions.

An exemplary embodiment of the disclosure is described below with reference to drawings.

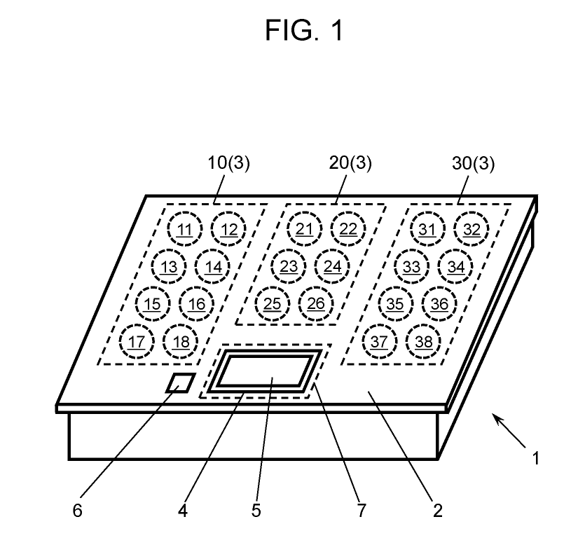

FIG. 1 is a perspective view of appearance of the heating cooker in the exemplary embodiment. As shown in FIG. 1, top plate 2 on which an object to be heated is placed is provided on the top face of heating cooker 1. Main power switch 6 and operation display unit 7 are provided on top plate 2.

Operation display unit 7 includes display 4 configured with a matrix liquid crystal display and touch panel 5 covering display 4. Operation display unit 7 displays on display 4 information prompting the user to operate via touch panel 5, and receives an input of the operation via touch panel 5.

IH coil group includes twenty-two IH coils (IH coils 11 to 18, 21 to 26, and 31 to 38) aligned as follows under top plate 2.

More specifically, eight IH coils (IH coils 11 to 18) are arranged to the left in a matrix of four lines by two rows close to each other under top plate 2. Heatable region 10 is configured on top plate 2 above these IH coils, and eight IH coils at maximum can be heated by induction heating.

In a small distance from heatable region 10, six IH coils (IH coils 21 to 26) are arranged at the center in a matrix of three lines by two rows close to each other under top plate 2. Heatable region 20 is configured on top plate 2 above these IH coils, and six IH coils at maximum can be heated by induction heating.

In a small distance from heatable region 20, eight IH coils (IH coils 31 to 38) are arranged to the right in a matrix of four lines by two rows close to each other under top plate 2. Heatable region 30 is configured on top plate 2 above these IH coils, and eight IH coils at maximum can be heated by induction heating.

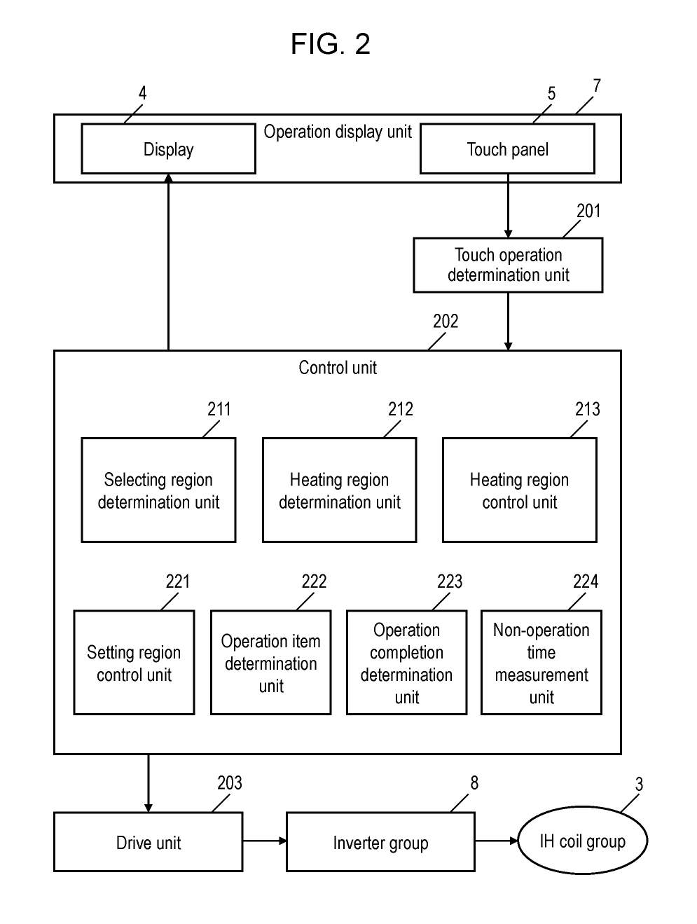

Heating cooker 1 further includes touch operation determination unit 201, control unit 202, drive unit 203, and inverter group 8 in its inside, as shown in FIG. 2.

Touch operation determination unit 201, control unit 202, and drive unit 203 are configured with integrated circuits (a microcomputer for control unit 202) independent from each other. Inverter group 8 includes twenty-two independent inverters, for example, for separately driving twenty-two IH coils.

FIG. 2 is a block diagram of the control of the heating cooker in the exemplary embodiment.

In FIG. 2, touch operation determination unit 201 determines whether or not information detected by touch panel 5 is a touch operation by the user, and outputs coordinate information on touch panel 5 for identifying a position where the touch operation has been executed. In the exemplary embodiment, the touch operation refers to a contact of part of human body, such as a finger of the user, with touch panel 5.

Control unit 202 displays a desired image on display 4 in response to information from touch operation determination unit 201, and notifies drive unit 203 to control each inverter in inverter group 8.

Drive unit 203 outputs a control signal to a switching element configuring each inverter in inverter group 8, according to notification from control unit 202. Each inverter in inverter group 8 supplies power for induction heating to corresponding IH coil, according to the control signal from drive unit 203. In other words, drive unit 203 drives IH coil group by controlling inverter group 8.

<Setting a Selection Region and Heating Region>

Next is described how to set a selection region on touch panel 5 and a heating region on top plate 2 with reference to drawings and a flow chart.

As shown in FIG. 2, control unit 202 includes selecting region determination unit 211 and heating region determination unit 212 for setting the selection region and heating region. They are configured with software operated in control unit 202 that is a microcomputer.

When coordinate information from touch operation determination unit 201 is within a predetermined region on touch panel, selecting region determination unit 211 sets a region on touch panel 5 selected by the touch operation to a selection region according to the coordinate information. Heating region determination unit 212 determines a heating region on top plate 2, corresponding to the set selection region.

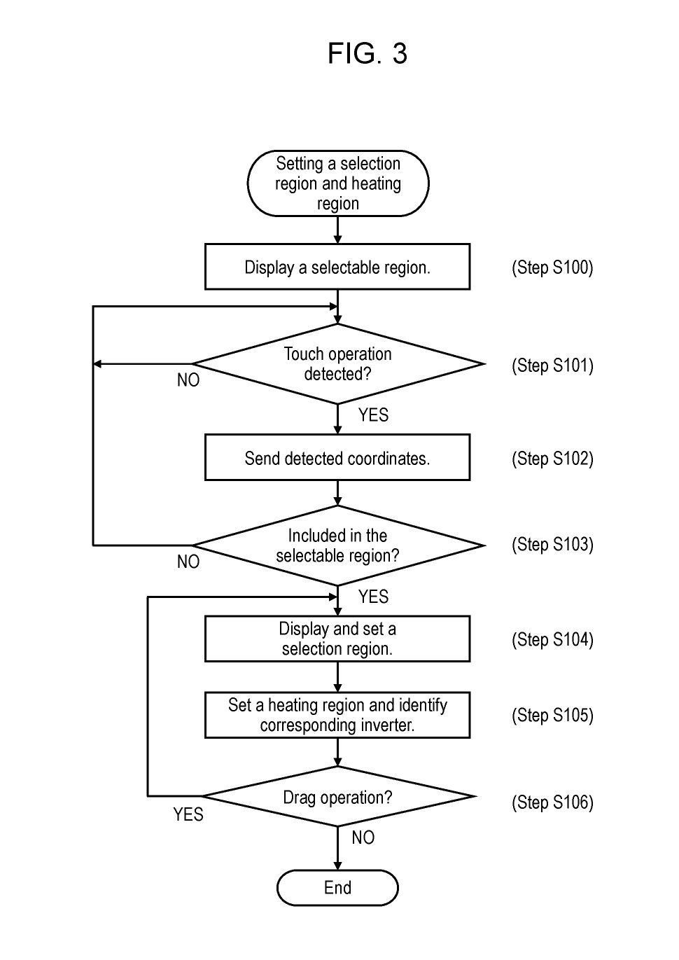

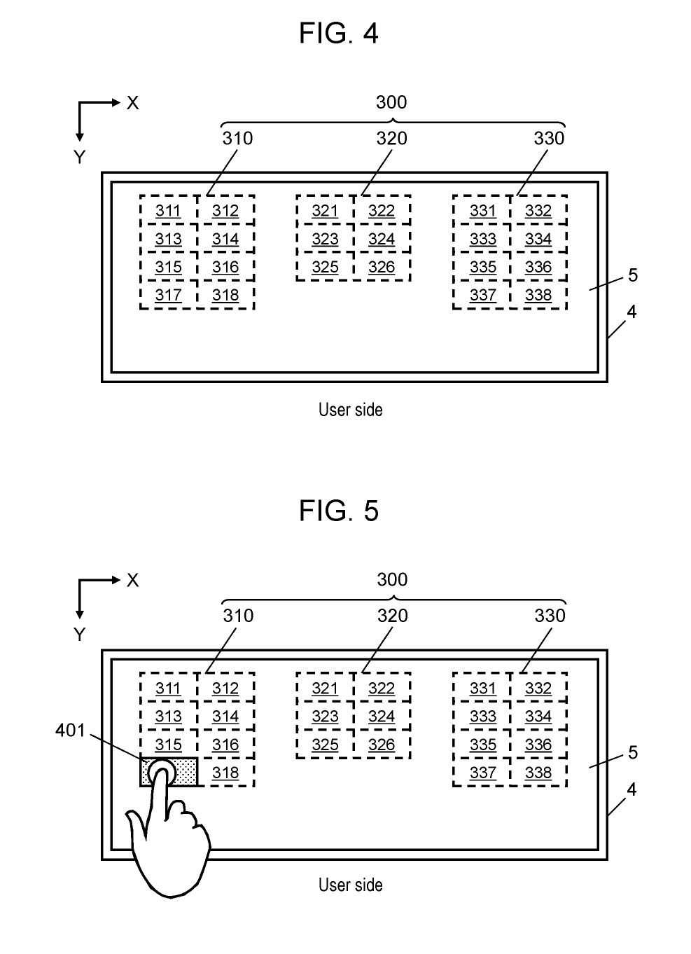

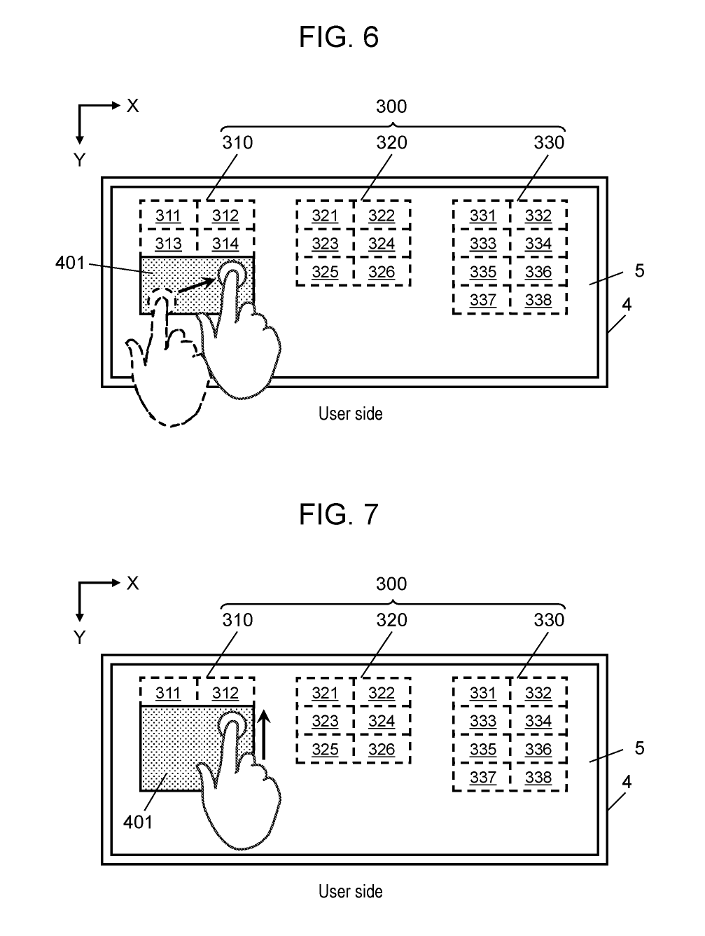

FIG. 3 is a flow chart illustrating how to set the selection region and heating region in the exemplary embodiments. FIG. 4 illustrates a state of display 4 displaying an initial image. FIG. 5 illustrates a state when a section touched is lighted. FIG. 6 and FIG. 7 illustrate states when multiple adjacent sections are lighted by a drag operation.

When the power of heating cooker 1 is turned on by operating main power switch 6, display 4 displays the initial image shown in FIG. 4 in Step S100. The initial image includes selectable region 310 displayed to the left of display 4, selectable region 320 displayed at the center of display 4, and selectable region 330 displayed to the right of display 4, as shown in FIG. 4.

Selectable region 310 is a region on touch panel 5 for selecting IH coils to be operated from IH coils 11 to 16 provided under heatable region 10 on top plate 2.

In the same way, selectable region 320 is a region on touch panel 5 for selecting IH coils to be operated from IH coils 21 to 26 provided under heatable region 20 on top plate 2. Selectable region 330 is a region on touch panel 5 for selecting IH coils to be operated from IH coils 31 to 38 provided under heatable region 30 on top plate.

As shown in FIG. 4, a coordinate system of coordinate information from touch operation determination unit 201 defines the top left corner of touch panel 5 as an origin, a sideway direction in FIG. 4 as X coordinate with its right side positive, and a front-back direction in FIG. 4 as Y coordinate with its front side positive. Selectable regions 310, 320, and 330 include sections 311 to 318, sections 321 to 326, and sections 311 to 318, respectively.

When touch operation determination unit 201 detects a touch operation on touch panel 5 by a change of static capacitance, while the initial image shown in FIG. 4 is displayed in step S101, touch operation determination unit 201 sends coordinate information corresponding to a position on touch panel 5 where the touch operation has been applied (hereinafter referred to as “detected coordinates”) to control unit 202 in step S102.

When selecting region determination unit 211 determines that the detected coordinates are not included in any of selectable regions 310, 320, and 330 in step S103, processing returns to Step S101.

When selecting region determination unit 211 determines that the detected coordinates are included in one of selectable regions 310, 320, and 330 in step S103, selecting region determination unit 211 executes the following processing in step S104.

Selection region determination unit 211 sets section 317 corresponding to the detected coordinates as selected region 401, and section 317 is lighted, as shown in FIG. 5.

Then, when a drag operation is applied from this state in the positive direction of X coordinate and the negative direction of Y coordinate (i.e., diagonally backward right), selecting region determination unit 211 sets all sections corresponding to detected coordinates, i.e., sections 315, 316, and 318, as selected region 401, in addition to section 317; and four sections in total are lighted, as shown in FIG. 6.

Then, when a drag operation is applied from this state in the negative direction of Y coordinate (i.e., backward), selecting region determination unit 211 sets sections 313 and 314 as selected region 401, in addition to sections 315 to 318; and six sections in total are lighted, as shown in FIG. 7.

When the touch operation and drag operation to touch panel 5 are completed, sections lighted at that point (sections 315 to 318 in FIG. 7) are set as final selected region 401 as a result of a series of touch operation and drag operation.

In step S105, heating region determination unit 212 associates sections 311 to 318, sections 321 to 326, and sections 311 to 318 with IH coils 11 to 18, 21 to 26, and 31 to 38, respectively. This sets the heating region corresponding to set selected region 401. Heating region determination unit 212 specifies a pair of IH coil and inverter corresponding to the set heating region.

As described above, the heating region on top plate can be set by a touch operation and drag operation to touch panel 5 in the exemplary embodiment. As a result, flexibility in the placement position of an object to be heated can be improved.

The exemplary embodiment refers to selectable region 310 as an example. A selected region is set and lighted by executing the same operation also in selectable region 320 and selectable region 330.

To facilitate user's recognition of the operation state, color or image of lighted selected region 401 during setting of selected region and after completing the setting may be changed in the exemplary embodiment.

In the exemplary embodiment, control unit 202 may be configured to change a range of selected region when a selected region is set and the same selected region is dragged within a predetermined time.

Even if the number of IH coils included in IH coil group 3 is increased and, for example, one heatable region covering almost the entire top plate 2 is provided, the effect same as the exemplary embodiment is achievable.

<Setting an Operation State of Heating Region>

Next, a method of setting the operation state of the heating region set on top plate 2 is described with reference to drawings and a flow chart.

As shown in FIG. 2, to set the operation state of the set heating region corresponding to selected region 401, control unit 202 includes heating region control unit 213, setting region control unit 221, and operation item determination unit 222. They are configured with software operated in control unit 202 that is a microcomputer.

The operation state of heating region refers to the operation of IH coil corresponding to the set heating region, and at least includes ‘heating’ and ‘stop.’ The power level accompanies the ‘heating’ operation.

Heating region control unit 213 notifies drive unit 203 to execute a desired operation for the above pair of IH coil and inverter, and stores the operation state of the heating region corresponding to this notification. Operation item determination unit 222 determines an operation item that can be set to the set heating region, according to the operation state of the heating region.

Setting region control unit 221 displays a setting region on display 4. The setting region includes a setting icon corresponding to the operation item determined by operation item determination unit 222.

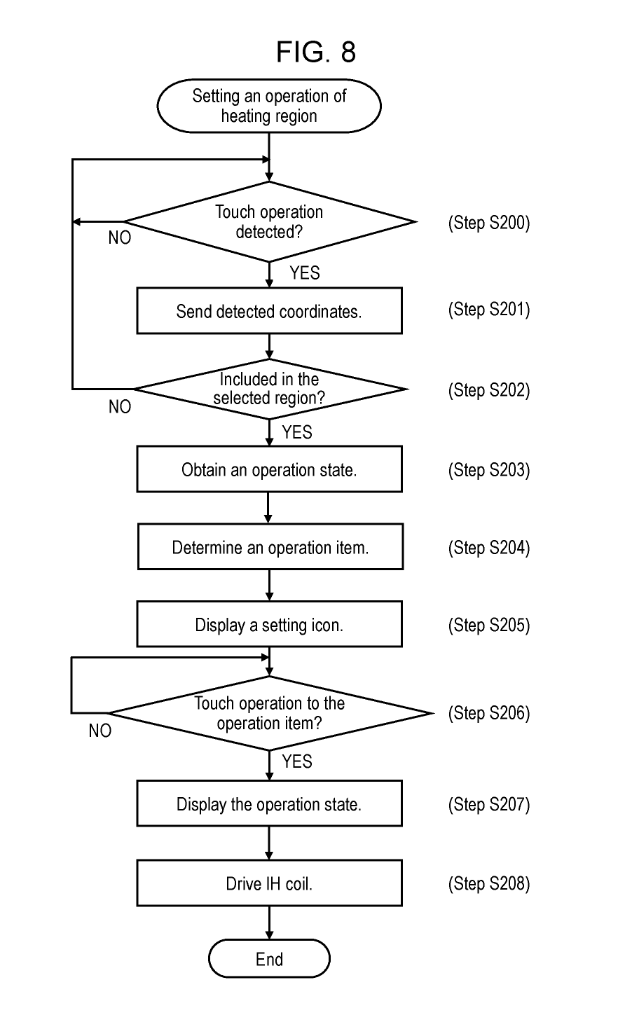

FIG. 8 is a flow chart indicating a method of setting the operation state of the selected region and heating region in the exemplary embodiments.

When touch operation determination unit 201 detects a touch operation on touch panel 5 while the image shown in FIG. 7 is displayed in step S200, touch operation determination unit 201 sends detected coordinates to control unit 202 in step S201.

In step S202, if setting region control unit 221 determines that the detected coordinates are not included in selected region 401, processing returns to step S200.

In step S202, if setting region control unit 221 determines that the detected coordinates are included in selected region 401, operation item determination unit 222 obtains the operation state of the heating region controlled by heating region control unit 21 in step S203.

In step S204, operation item determination unit 222 determines a settable operation item based on the state of heating region, and setting region control unit 221 displays a setting region, including a setting icon corresponding to the determined operation item, on display 4 in step S205.

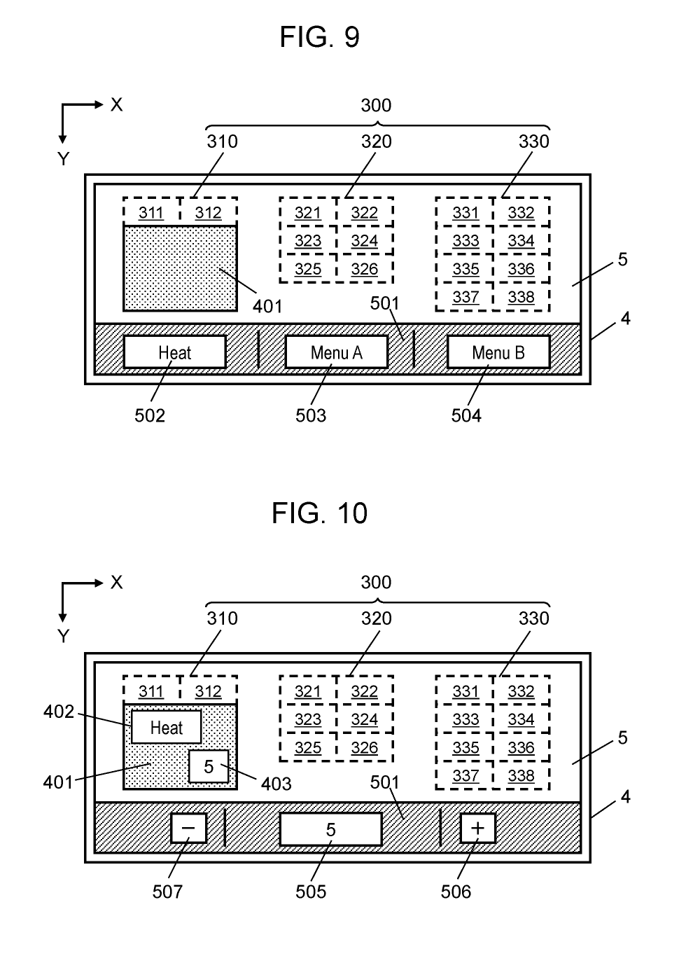

FIG. 9 shows the state that setting region 501 is displayed on display 4.

As shown in FIG. 9, after processing in step S205, display 4 displays setting region 501, including setting icons 502, 503 and 504. Setting icons 502, 503, and 504 are determined by operation item determination unit 222, and settable operation items according to the state of heating region is displayed.

Characters for setting the operation state of the heating region to “heat” is displayed in setting icon 502. Characters for setting the operation state of the heating region to “Menu A,” which is predetermined auto-cooking, are displayed in setting icon 503. Characters for setting the operation of the heat region to “Menu B,” which is another predetermined auto-cooking, are displayed in setting icon 504.

In step S206, setting region control unit 221 waits for a touch operation on one of setting icon 502, setting icon 503, and setting icon 504 while setting region 501 is displayed.

When setting region control unit 221 detects the touch operation, the operation state corresponding to an operated setting icon is displayed on selected region 401 in step S207. Heating region control unit 213 stores the operation state.

FIG. 10 illustrates the state that an operation state is displayed in the setting region after processing in step S207. As shown in FIG. 10, state 402 indicating the present operation state of the heating region and power level 403 indicating the present power level are displayed on selected region 401. State 402 and power level 403 may also be displayed near selected region 401, instead of on selected region 401.

The setting icon displayed in setting region 501 is then switched. Power level 505 indicating the present power level, power control icon 506 to increase the power level by one step, and power control icon 507 to decrease the power level by one step are displayed on setting region 501.

When power control icon 506 or 507 is operated, heating region control unit 213 increases or decreases the set power level by one step, according to the operation.

Lastly, in step S208, heating region control unit 213 notifies the operation state of the heating region corresponding to the operated setting icon to drive unit 203. Drive unit 203 then drives IH coil group 3 according to the notification from control unit 202.

As described above, setting region 501 for setting the operation state of set heating region is switched and displayed according to the present operation state in the exemplary embodiment. In other words, many setting icons are not simultaneously displayed on display 4. A new setting icon for probable subsequent operation is displayed sequentially after each operation of the setting icon. As a result, operability can be improved.

In the exemplary embodiment, state 402 and power level 403 are displayed on selected region 401 or near selected region 401. This can easily associate the heating region with the operation state and power level of that heating region.

Setting icons displayed in setting region 501 may display other than the operation state. For example, types of auto-cooking menus may be changed according to the size and position of selected region 401.

<Completing Display of Setting Region>

Next is described the timing to stop displaying setting region 501, with reference to drawings and a flow chart.

As shown in FIG. 2, control unit 202 includes operation completion determination unit 223 and non-operation time measurement unit 224 for terminating display of setting region 501. They are configured with software operated in control unit 202 that is a microcomputer.

Operation completion determination unit 223 determines whether or not the setting using setting region 501 has been completed. When the setting using setting region 501 has been completed, i.e., when there is no further setting icon to switch to and display in setting region 501, operation completion determination unit 223 notifies of it to setting region control unit 221.

Non-operation time measurement unit 224 measures the time that no touch operation is applied to setting region 501 after setting region 501 is displayed, i.e., the time of no operation in setting region 501. If the non-operation time exceeds a predetermined time, non-operation time measurement unit 224 notifies of it to setting region control unit 221.

Based on these notifications, setting region control unit 221 deletes setting region 501 from display 4.

As described above, in the exemplary embodiment, the effort of the user can be saved by automatically deleting setting region 501 upon fulfilling a predetermined condition.

In the exemplary embodiment, the predetermined time related to non-operation time may be changed, for example, using operation display unit 7.

<Setting Multiple Setting Regions and Heating Regions>

When a touch operation and drag operation are applied to selectable region 320, while setting region 501 is displayed, control unit 202 sets new selection region on selectable region 320 to set a new heating region on top plate 2, corresponding to this new selection region.

When a touch operation is executed to this new selection region, control unit 202 switches content displayed in setting region 501 to display a new setting icon corresponding to the new heating region.

Accordingly, multiple heating regions can be set on top plate 2 and the operation state of each heating region can be set separately in the exemplary embodiment.

### INDUSTRIAL APPLICABILITY

As described above, the operation display device of the disclosure is applicable to commercial and industrial heating cookers, including IH cooking heaters.

### REFERENCE MARKS IN THE DRAWINGS

1 Heating cooker
2 Top plate
3 IH coil group
4 Display
5 Touch panel
6 Main power switch
7 Operation display unit
8 Inverter group
10, 20, 30 Heatable region
11-18, 21-26, 31-38 IH coil
201 Touch operation determination unit
202 Control unit
203 Drive unit
211 Selecting region determination unit
212 Heating region determination unit
213 Heating region control unit
221 Setting region control unit
222 Operation item determination unit
223 Operation completion determination unit
224 Non-operation time measurement unit
310, 320, 330 Selectable region
401 Selected region
402 State
403, 505 Power level
501 Setting region
502, 503, 504 Setting icon
506, 507 Power control icon

1. A heating cooker comprising:
a top plate on which an object to be heated is placed;
a plurality of IH coils provided under the top plate for heating the object to be heated by induction heating;
an operation display unit configured with a touch panel for displaying information prompting an operation via the touch panel and receiving an input of the operation via the touch panel;
a drive unit for driving the plurality of IH coils; and
a control unit for controlling the operation display unit and the drive unit, according to the operation input to the operation display unit,
wherein
the control unit sets a selection region on the touch panel, and a heating region on the top plate, according to a drag operation on the touch panel,
the operation display unit displays the selection region, and
the drive unit drives at least one of the IH coils corresponding to the heating region.

2. The heating cooker of claim 1,
wherein
the operation display unit is configured to display a selectable region in which the selection region can be set.

3. The heating cooker of claim 1,
wherein
the operation display unit is configured to display a setting region for setting an operation state of the heating region, according to an operation to the selection region.

4. The heating cooker of claim 3,
wherein
the setting region includes a setting icon for setting the operation state of the heating region, and the operation display unit is configured to display another setting icon in the setting region, according to an operation to the setting icon.

5. The heating cooker of claim 3,
wherein
the operation display unit is configured to display the operation state of the heating region in the selection region or near the selection region.

6. The heating cooker of claim 3,
wherein
the operation display unit is configured to delete the setting region when setting of the operation state using the setting region is completed.

7. The heating cooker of claim 3,
wherein
the operation display unit is configured to delete the setting region after a predetermined time passes since the setting region starts to be displayed.

8. The heating cooker of claim 3,
wherein
while the setting region is displayed,
the control unit sets:
a new selection region on the touch panel, according to a drag operation on the touch panel, and
a new heating region on the top plate, corresponding to the new selection region, and
the operation display unit displays a new setting region for setting an operation state of the new heating region, according to an operation to the new selection region.
